(19) United States
(12) Patent Application Publication
(10) Pub. No.: US 2015/0164143 A1
(43) Pub. Date: Jun. 18, 2015

(54) Electronic Simulated Cigarette and its Vaporizer

(71) Applicant: Bernard Karel Maas, Hamont Achel (BE)

(72) Inventor: Bernard Karel Maas, Hamont Achel (BE)

(21) Appl. No.: 14/374,752

(22) PCT Filed: Jan. 25, 2012
(86) PCT No.: PCT/CN2012/070717

§ 371 Date: Jul. 25, 2014

(51) Int. Cl. A24F 47/00; H05B 3/12; H05B 1/02; H05B 3/02

(52) U.S. Cl. CPC A24F 47/008; H05B 3/026; H05B 3/12; H05B 1/0244

(57) ABSTRACT

The present invention relates to an electronic simulation cigarette comprising a simulation mouthpiece and a cigarette stem, wherein a battery and an electronic circuit are provided in the cigarette stem; the simulation mouthpiece includes a mouthpiece sleeve, a liquid storage device and an vaporizer; the vaporizer and the liquid storage device are fixed inside the mouthpiece sleeve; the vaporizer includes a shell, a heating element mounted inside the shell, an electrically conductive element configured to electrically connect the heating element to the battery, and a space reserved for air flow inside the shell; the vaporizer also includes a distribution body configured to cover the heating element for absorbing a substance inside the liquid storage device and conducting heat generated by the heating element. The distribution body is made of ceramic. The liquid inside the liquid storage device of the present invention can be uniformly distributed around the heating element, to thereby save the raw material and improve the vaporization efficiency. Moreover, such a kind of vaporizer has a simple structure and can reduce the production cost.

### TECHNICAL FIELD

The present invention relates to a personal smoking device, and particularly an electronic simulation cigarette and a vaporizer thereof.

### BACKGROUND ART

At present, it is commonly known that “smoking is harmful to your health”. Statistics show that the number of deaths caused by smoking each year is several millions. However, there are still about one billion smokers around the world, and the number is continuously increasing. Moreover, due to mental or physical reasons, such as addiction to cigarettes or dependence on cigarettes, it is very difficult for the smokers to quit smoking. Therefore, more and more people choose to smoke an electronic simulation cigarette instead of a tobacco cigarette.

The prior art provides some electronic smoking devices, which are also called electronic cigarettes (E-cigarette), simulation cigarettes or cigarette substitutes, to replace tobacco cigarettes or produce an aerosol mist to be inhaled by the users. These electronic smoking devices usually comprise a mouthpiece, a battery, a liquid storage chamber and a vaporizer. The mouthpiece enables the user to smoke the electronic smoking device, and the battery supplies electric power to the electronic smoking device. The liquid in the liquid storage chamber enters the vaporizer so as to be vaporized by the vaporizer and then dispersed from the mouthpiece. The liquids used by these electronic smoking devices do not contain harmful components such as tar and nicotine, or only contain a small amount of nicotine based on the user's demand. The liquids used by these electronic smoking devices may be smoking solutions that simulate the taste of cigarettes, or medical solutions for medical treatment, oral cleanser, or vaporizable and nutritious solutions, or gels having liquidity. These liquids will not generate tar during the vaporizing process, and will not generate a great amount of harmful substances to cause injury to the human body after being burnt. However, these liquids can cause the users to feel excited as if they were smoking real cigarettes, can help the smokers quit smoking, and can be used on the occasions where smoking of tobacco cigarettes is forbidden.

Nonetheless, after these liquids or gels having liquidity are heated at a high temperature and then vaporized by the vaporizer, harmful substances might be generated. These harmful substances might be inhaled by the users of the simulation cigarettes, and might bring risks to the health of the users. The existence of this disadvantageous effect is contrary to the initial purpose for using the simulation cigarettes.

Further, since elements such as a battery, a liquid storage chamber and a vaporization chamber need to be mounted inside the existing electronic cigarettes, the electronic cigarettes usually have a larger size than the ordinary cigarettes. For example, in the atomization electronic cigarette disclosed by the international patent application with the Publication Number WO2005/099494, the electronic circuit board, the atomizer, the liquid-supplying bottle and so on are integrated inside the shell of the electronic cigarette, so the size of the shell is obviously larger than the size of the real conventional cigarette. For another example, in the international patent application with the Publication Number WO2011/146318, the liquid storage chamber is provided at the distal end of the cigarette stem, whereas the vaporizer is provided between the mouthpiece and the liquid storage chamber. Such a structure is complex. Moreover, a part of the liquid in the liquid storage chamber is distant from the vaporizer and cannot come into full contact with the vaporizer, so the vaporization efficiency is low.

Besides, the structure of the vaporizer is complex, and the liquid guiding element cannot come into full contact with the heater wire, so the heating efficiency is low.

### DISCLOSURE OF THE INVENTION

The present invention aims to solve the technical problem of providing an electronic simulation cigarette and a vaporizer thereof capable of reducing the generation of harmful substances during the heating and improving the heating and vaporization efficiency, and such a kind of vaporizer has a simple structure and can reduce the production cost.

In order to solve the above-mentioned technical problem, the technical solution adopted by the present invention provides a vaporizer comprising a shell, a heating element mounted inside the shell, an electrically conductive element configured to electrically connect the heating element to a power source, and a space reserved for air flow inside the shell, wherein the vaporizer also comprises a distribution body configured to cover the heating element for absorbing a substance inside a liquid storage device and conducting heat generated by the heating element.

Further, the distribution body is made of ceramic.

Further, the distribution body is formed by coating ceramic powder on the surface of the heating element at a high temperature.

Further, the heating element is made into a line shape (wire shape).

Further, the heating element is at least partially curved.

Further, the heating element is at least partially curved into a spiral shape.

Further, ceramic powder wraps the part of the heating element that is curved into the spiral shape.

Further, the heating element is made of a nickel alloy.

Further, the heating element is plated with gold or a gold alloy.

Further, the resistance value of the heating element is within a range of 4.5 to 7.0 ohm.

Further, the resistance value of the heating element is 5.5 ohm.

The present invention also provides an electronic simulation cigarette comprising a simulation mouthpiece and a cigarette stem, a battery and an electronic circuit being provided in the cigarette stem, the simulation mouthpiece including a mouthpiece sleeve, a liquid storage device and a vaporizer, the vaporizer and the liquid storage device being fixed inside the mouthpiece sleeve, the vaporizer including a shell, a heating element mounted inside the shell, an electrically conductive element configured to electrically connect the heating element to the battery, and a space reserved for air flow inside the shell, wherein the vaporizer also includes a distribution body configured to cover the heating element for absorbing a substance inside the liquid storage device and conducting heat generated by the heating element.

Further, the distribution body is made of ceramic.

Further, the distribution body is formed by coating ceramic powder on the surface of the heating element at a high temperature.

Further, the heating element is made into a line shape.

Further, the heating element is at least partially curved.

Further, the heating element is at least partially curved into a spiral shape.

Further, ceramic powder wraps the part of the heating element that is curved into the spiral shape.

Further, the heating element is made of a nickel alloy.

Further, the heating element is plated with gold or a gold alloy.

Unlike the liquid supplying method of the existing electronic simulation cigarettes, due to the structure of the present invention and the use of the distribution body, the liquid in the liquid storage device of the present invention can completely flow into the vaporizer and be fully distributed around the heating element, to thereby save the raw material and improve the vaporization efficiency. Moreover, such a kind of vaporizer has a simple structure and can reduce the production cost.

### BRIEF DESCRIPTION OF THE DRAWINGS

FIG. 1 is an overall schematic diagram showing the electronic simulation cigarette of the present invention.

FIG. 2 is a disassembled diagram showing the simulation mouthpiece of the electronic simulation cigarette of the present invention.

FIG. 3 is a schematic diagram showing the heating element and the distribution body of the vaporizer in the electronic simulation cigarette of the present invention.

FIG. 4 is a perspective view showing the heating element and the distribution body of the vaporizer in the electronic simulation cigarette of the present invention.

### MODES FOR CARRYING OUT THE INVENTION

Hereinafter, the present invention is described in detail with reference to the drawings.

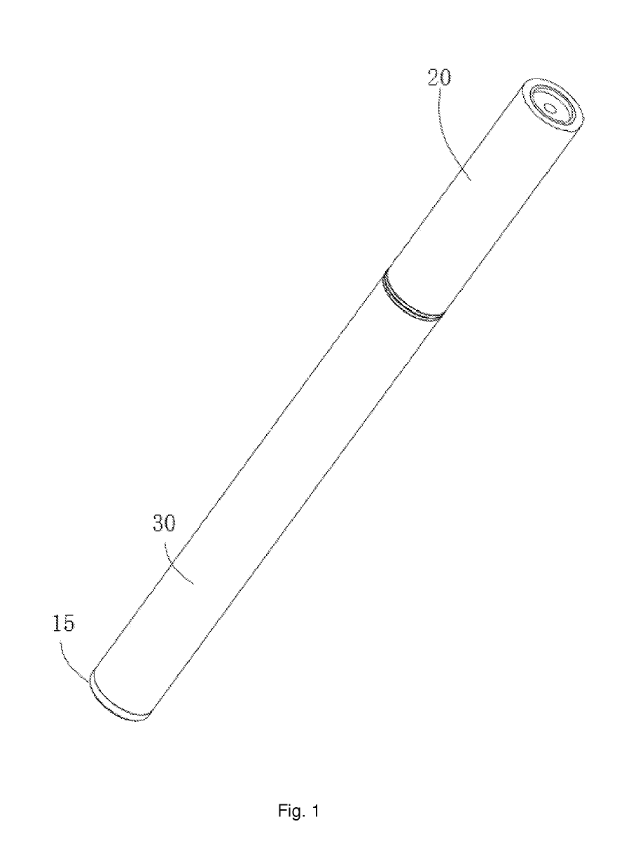

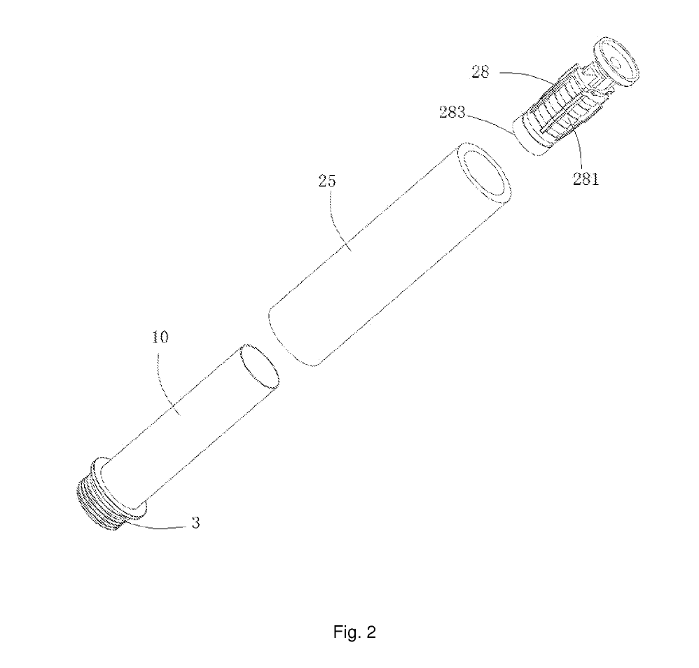

As shown in FIG. 1 and FIG. 2, the electronic simulation cigarette of the present invention includes a simulation mouthpiece 20 and a cigarette stem 30. A battery and an electronic circuit are provided in the cigarette stem 30. The cigarette stem 30 is made of plastic or a similar material. One end of the cigarette stem 30 is provided with a flame simulation device 15. A simulation mouthpiece 20 is attached to the other end of the cigarette stem 30. When the electronic simulation cigarette is powered on and enters an in-use state, a flow of aerosol mist vaporized by a vaporizer 10 enters the mouth of the user through the simulation mouthpiece 20.

As shown in FIG. 2, the simulation mouthpiece 20 includes a mouthpiece sleeve 25, a liquid storage device 28, and a vaporizer 10. The vaporizer 10 and the liquid storage device 28 are fixed inside the mouthpiece sleeve 25. The mouthpiece sleeve 25 has a tube shape and is made of a soft material to cover the outer wall of the simulation mouthpiece 20.

The liquid storage device 28 includes a container 281, and a sealing film 283 that seals the top of the container 281. The container 281 and the sealing film 283 are made of a non-rigid material such as PE, PC or PU. In this embodiment, the container 281 is in a substantially cylindrical shape, and a liquid or a gel having liquidity of approximately 0.3 to 2.0 ml can be injected into the container 281. The outer shape of the container 281 of the liquid storage device 28 enables the liquid storage device 28 to be not only engaged with the inner wall of the mouthpiece sleeve 25 but also reserve a space between itself and the inner wall of the mouthpiece sleeve 25 so that an gas flow can pass through. The distal end of the liquid storage device 28 can be fitted with the vaporizer 10 and is partially inserted into one end of the vaporizer 10, but there is a space therebetween for air and gas to pass through.

One end of the vaporizer 10 is adjacent to the liquid storage device 28, and the other end thereof is connected to the cigarette stem 30. In this embodiment, the diameter of the vaporizer 10 is approximately 5 mm to 7 mm so as to be fitted with the inner wall of the mouthpiece sleeve 25.

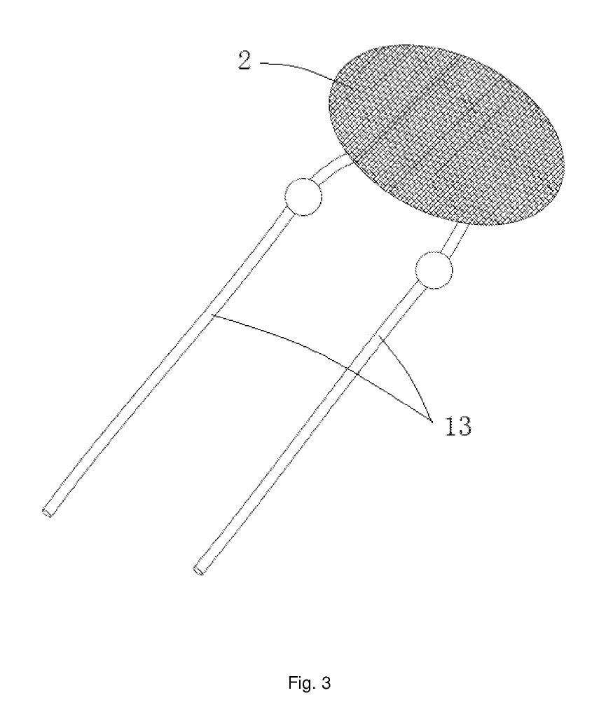

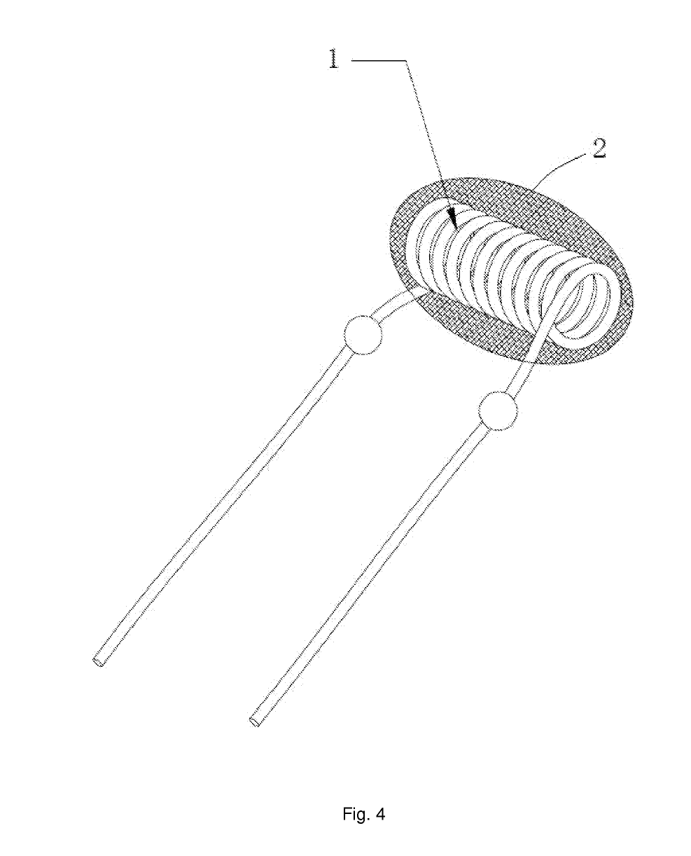

Referring to FIGS. 3-4 in addition, the vaporizer 10 includes a shell 11, a heating element 1 mounted inside the shell 11, and a distribution body 2 configured to cover the heating element 1, to absorb a substance inside the liquid storage device 28, and to conduct heat generated by the heating element. The heating element 1 is embedded in the distribution body 2 with no gap therebetween. A space for air or gas to pass through is reserved inside the vaporizer 10.

The shell 11 is configured to receive the heating element and the distribution body, and to work together with the liquid storage device 28 so as to hold the liquid in a space consisting by the liquid storage device 28 and the shell 11. The shell 11 is a cylindrical sleeve and is made of stainless steel. The shell 11 has an open end with a circular opening. The distal end of the liquid storage device 28 on which the sealing film 283 is provided can be inserted into the opening and be received by the shell 11. The mouthpiece sleeve 25 shields the outer periphery of the shell 11.

The heating element 1 has the characteristic of rapidly increasing its temperature when being powered on and can rapidly heat the liquid or a thermal conductive device attached to the surface thereof. After being heated by the heating element, the liquid is vaporized. The heating element 1 is made of metal and has a pair of terminals respectively connected to a high-voltage terminal and a low-voltage terminal of a power source. In the present invention, the heating element 1 is a metal wire. The heating element 1 is made of a nickel alloy. In the present invention, the heating element is formed into a line shape. The heating element is at least partially curved so as to increase its contact area with the liquid per unit length. In this embodiment, the intermediate portion of the heating element 1 is curved into a spiral shape and looks like a spring. In many embodiments, the cross section of the heating element may be circular, oval, or rectangular. Both ends of the heating element 1 are electrically coupled to the positive and negative electrodes of the power source respectively via an electrically conductive element. The surface of the heating element is covered by gold or a gold alloy, which is plated on the heating element. Preferably, the gold or gold alloy is electroplated on the heating element through the electroplating technique. The gold or gold alloy is health for the human body and is an edible metal. After the surface of the heating element is plated with gold, the liquid does not come into direct contact with the heating element but contacts the gold or gold alloy and is heated and vaporized at a high temperature on the gold or gold alloy, to thereby efficiently reduce the generation of harmful substances and be more healthy and clean for the humans.

After the heating element is powered on, a voltage having the voltage value of 3.6 V is input into the heating element. The heating element transforms the electric energy into thermal energy and generates a high temperature to rapidly heat the liquid or the thermally conductive device attached to the surface thereof. The resistance value of the heating element is within a range of 3.5 to 7.0 ohm. More preferably, the resistance value thereof is within a range of 4.5 to 7.0 ohm. In this embodiment, the resistance value of the heating element is 5.5 ohm.

The distribution body 2 is hydrophilic and can absorb water. It also has the characteristics of heat resistance and rapid thermal conductivity. The distribution body 2 is made of ceramic. The distribution body 2 is formed by coating ceramic powder on the surface of the heating element at a high temperature. Preferably, ceramic powder wraps the intermediate portion of the heating element that is curved into a spiral shape. The ceramic powder is an environmentally friendly and healthy substance, and can be applied to the medical field such as denture manufacture, so it has no harm for the humans. The characteristics of the ceramic material are high temperature resistance and rapid heat conductivity. It can absorb the heat generated by the heating element, and vaporizes the liquid absorbed on the ceramic at a high temperature. The distribution body made of ceramic can rapidly absorb liquid and uniformly distribute the liquid around the heating element, to thereby improve the vaporization efficiency and achieve a desirable aerosol mist effect.

Besides, the liquid does not come into direct contact with the heating element but is heated and vaporized on the ceramic, to thereby reduce the generation of harmful substances and be more environmentally friendly and healthy.

In order to make the vaporizing process more healthy and clean and reduce the generation of harmful substances, all the surfaces of the metal components that contact the liquid within the vaporizer are covered by gold or a gold alloy. The gold or gold alloy is electroplated to these metal components through the electroplating technique. In this embodiment, the shell 11 of the vaporizer is plated with gold or a gold alloy.

In some embodiments, the heating element is not plated with gold or a gold alloy, so there is no gold or gold alloy layer interposed between the heating element and the distribution body.

The vaporizer 10 also includes an electrically conductive element, which has a first electrically conducive terminal 3 and a second electrically conductive terminal (not shown) that are connected to the positive and negative electrodes of the power source respectively, and which also has a lead wire 13. The first electrically conductive terminal 3 is electrically connected to the negative electrode of the power source. In this invention, the power source is a chargeable battery (which is mounted inside the cigarette stem 30 and not shown). The shape of one end of the first electrically conductive terminal 3 is adapted for mounting the shell 11, and the other end thereof is formed into a screw or clutch engaged with the screw or clutch of the cigarette stem 30 so as to be connected to the cigarette stem 30. That is to say, in the present invention, the first electrically conductive terminal 3 is also a connection device for connecting the simulation mouthpiece 20 to the cigarette stem 30. The second electrically conductive terminal 1 is electrically connected to the negative electrode of the battery. An insulator is mounted between the first electrically conductive terminal 3 and the second electrically conductive terminal so as to prevent short circuit. In the present invention, the second electrically conductive terminal is mounted inside the first electrically conductive terminal 3. The first electrically conductive terminal 3 and the second electrically conductive terminal 1 are connected to both ends of the heating element respectively via the lead wires 13. The first electrically conductive terminal 3 and the second electrically conductive terminal 1 are made of an electrically conductive material such as brass.

During assembly, the liquid storage device 28 is shielded in one end of the mouthpiece sleeve 25, and they are integrated into a relatively independent pre-mounted structure. The vaporizer 10 is screwed into the cigarette stem 30, and they are integrated into a relatively independent pre-mounted structure. In use, the mouthpiece sleeve 25 in which the liquid storage device 28 is integrated is aligned with the vaporize 10 and is then pressed to shield the vaporizer 10. At this time, the front end of the liquid storage device 28 inside the mouthpiece sleeve 25 is received by the open end of the vaporizer 10, and the liquid in the liquid storage device 28 gradually permeates the distribution body 2 of the vaporizer 10. When the mouth of the user sucks the simulation mouthpiece 20, a pneumatic switch in the electronic circuit activates the electronic simulation cigarette to be powered on and enter an in-use state, in response to the action of the user. The vaporizer 10 is powered on and starts to work. The heating element 1 gradually vaporizes the liquid absorbed by the distribution body 2, and then an aerosol mist enters the mouth of the user via the space for gas passing through.

The mouthpiece sleeve 25 in which the liquid storage device 28 is integrated is a disposable product. When the liquid in the liquid storage chamber is used up, the liquid storage chamber and the mouthpiece sleeve can be together removed from the vaporizer and discarded, and then a new mouthpiece sleeve in which a liquid storage chamber is integrated shields the vaporizer, so as to guarantee cleanness and convenience in replacement.

Unlike the liquid supplying method of the existing electronic simulation cigarettes, due to the structure of the present invention and the use of the distribution body, the liquid in the liquid storage device of the present invention can completely flow into the vaporizer and be fully distributed around the heating element, to thereby save the raw material and improve the vaporization efficiency. Moreover, such a kind of vaporizer has a simple structure and can reduce the production cost.

1. A vaporizer comprising a shell, a heating element mounted inside the shell, an electrically conducting element for electrically connecting the heating element and the electrical supply source as well as a space ensuring the air circulation in the shell, wherein the vaporizer also comprises a distribution body that covers the heating element and that serves for absorbing the substance contained in the liquid storage device and to conduct heat generated by the heating element.

2. The vaporizer according to claim 1, wherein the distribution body is made of ceramic.

3. The vaporizer according to claim 1, wherein the distribution body is formed by coating ceramic powder on the surface of the heating element at a high temperature.

4. The vaporizer according to claim 1, wherein the heating element is made into a wire shape.

5. The vaporizer according to claim 1, wherein at least one part of the heating element is curved.

6. The vaporizer according to claim 1, wherein at least one part of the heating element is curved into a spiral shape.

7. The vaporizer according to claim 6, wherein the ceramic powder wraps the part of the heating element that is curved into the spiral shape.

8. The vaporizer according to claim 1, wherein the heating element is made of a nickel alloy.

9. The vaporizer according to claim 1, wherein the heating element is plated with gold or a gold alloy.

10. The vaporizer according to claim 1, wherein the resistance value of the heating element is within a range of 4.5 and 7.0 Ohm.

11. A heating element for a vaporizer according to claim 1, wherein the resistance of the heating element is 5.5 Ohm.

12. An electronic simulation cigarette comprising a simulation mouthpiece and a stem, the stem containing a battery and an electronic circuit, the mouthpiece comprising a sleeve, a liquid storage device and a vaporizer, the vaporizer and the storage device being fixed inside the mouthpiece, the vaporizer comprising a shell, a heating element mounted inside the shell, a conductive element for electrically connecting the heating element and the electrical supply source as well as a space ensuring the air circulation in the shell, this electronic simulation cigarette being characterized in that the vaporizer also comprises a distribution body that covers the heating element and that serves for absorbing the substance contained in the liquid storage device and to conduct heat generated by the heating element.

13. The electronic simulation cigarette according to claim 12, wherein the distribution body is made of ceramic.

14. The electronic simulation cigarette according to claim 12, wherein the distribution body is formed by coating ceramic powder on the surface of the heating element at a high temperature.

15. The electronic simulation cigarette according to claim 12, wherein the heating element is made into a wire shape.

16. The electronic simulation cigarette according to claim 12, wherein at least one part of the heating element is curved.

17. The electronic simulation cigarette according to claim 12, wherein at least one part of the heating element is curved into a spiral shape.

18. The electronic simulation cigarette according to claim 17, wherein the ceramic powder wraps the part of the heating element that is curved into the spiral shape.

19. The electronic simulation cigarette according to claim 12, wherein the heating element is made of a nickel alloy.

20. The electronic simulation cigarette according to claim 12, wherein the heating element is plated with gold or a gold alloy.
